(19) United States
(12) Patent Application Publication
(10) Pub. No.: US 2009/0061381 A1
(43) Pub. Date: Mar. 5, 2009

(54) Systems and methods for 3D previewing

(76) Inventors: Duane Milford Durbin, San Diego, CA (US); Dennis Arthur Durbin, Solana Beach, CA (US)

Correspondence Address: Duane Durbin, 7660 Norcanyon Way, San Diego, CA, 92126, US

(21) Appl. No.: 11/899,070

(22) Filed: Sep. 5, 2007

(51) Int. Cl. A61C 11/00; A61C 7/00

(52) U.S. Cl. 433/24; 433/213

(57) ABSTRACT

Systems and methods are disclosed to preview a scan includes placing a three dimensional (3D) scanner probe near an object to be scanned; scanning a portion of the object to generate a 3D model of the scanned portion of the object; and displaying the 3D model of the portion as a live 3D preview of the 3D model, wherein the live 3D preview provides feedback on the probe's position and orientation relative to the object.

Determination of the surface contour of objects by non-contact optical methods has become increasingly important in many applications, including dental three dimensional (3D) modeling. In many dental applications, a physical or digital model of a patient's teeth is needed that faithfully reproduces the patient's teeth and other dental structures, including the jaw structure. Conventionally, a 3D negative model of the teeth and other dental structures is created during an impression-taking session where one or more trays are filled with a putty like dental impression material and the tray is then placed over the teeth to create a negative mold. Once the impression material has hardened, the tray of material is removed from the teeth and a plaster like material is poured into the negative mold formed by the impression. After hardening, the poured plaster material is removed from the impression mold and, as necessary, finish work is performed on the casting to create the final physical model of the dental structure. Typically a physical model will include at least one tooth and the adjacent region of gingiva. Physical models may also include all of the teeth of a jaw, the adjacent gingiva and, for the upper jaw, the contour of the palate. These physical models can then be used as patterns to fabricate dental restorations such as crowns or bridges or to plan orthodontic treatment. In addition, all or part of the negative mold or physical dental model may be scanned on a bench top 3D scanner system to create a digital 3D model of the physical model, with the digital 3D model being available as input to a variety of Computer Aided Design/Computer Aided Manufacture (CAD/CAM) processes now being used by the dental industry.

Automated dental structure intra oral optical impression techniques have been developed as alternatives to the conventional mold casting procedure in which a 3D negative model of the teeth and other dental structures is created during an impression-taking session. Because the intra oral dental optical impression techniques can create a direct digital 3D model representation of the dental structures, they provide the advantage of creating a “digital impression” that is immediately transmittable from the patient to a dental Computer Aided Design (CAD) system and, after review and annotation by a dentist, to a dental laboratory. The digital transmission potentially diminishes inconvenience for the patient, eliminates the risk of damage to the impression mold, and eliminates the propagation of errors that may occur during the creation of a plaster physical model.

To obtain an accurate digital 3D model of the human dentition in vivo (intra oral optical impression) with sufficient fidelity to produce high quality dental restorations is a difficult task that constrains the approach to a small subset of the known non-contact optical methods—principally: 1) triangulation based methods; 2) confocal macroscopy based methods; or 3) coherence tomography based methods. Each of these methods however is typically limited by the fundamental design trade-off between the lateral resolution of an optical system and the depth of field of the same system—i.e. the higher the system lateral resolution the shallower the depth of field. For intra oral optical impressions, this trade-off of lateral resolution versus depth of field is particularly sensitive because the fine lateral resolution required for the imaging system generally imposes a limitation on the depth of field which makes intra oral placement of the optical impression system by the user more critical.

U.S. Pat. No. 6,364,660, the content of which is incorporated by reference, teaches a methodology and apparatus to allow for rapid intra oral images to be taken of dental structures in such a way, and with sufficient lateral resolution such that the acquired images can be processed into accurate digital 3D models of the imaged dental structures. The images and models have application in dental diagnosis and for the specification and manufacture of dental prosthetics such as bridgeworks, crowns or other precision moldings and fabrications. U.S. Pat. No. 6,592,371, the content of which is incorporated by reference, teaches coating of a structure such as a dental structure with a luminescent substance to enhance the image quality and improve range determination accuracy by active triangulation techniques using either white light or laser light.

Triangulation methods for 3D ranging are based on elementary geometry. Given a triangle with the baseline of the triangle composed of two optical centers and the vertex of the triangle the target, the range from the target to the optical centers can be determined based on the optical center separation and the angle from the optical centers to the target. The target in this case is the surface of the object of interest.

Triangulation methods can be divided into passive and active. Passive triangulation (also known as stereo analysis) utilizes ambient light and both optical centers are cameras. In its most basic embodiment, active triangulation uses only a single camera and, in place of the other camera, uses a source of controlled illumination (also known as structured light). Stereo analysis while conceptually simple is not widely used because of the difficulty in obtaining correspondence between camera images. For example, on objects with well-defined edges and corners, such as blocks, it may be rather easy to obtain correspondence, but on objects with smoothly varying surfaces, such as skin or tooth surfaces, with no easily identifiable points to key on, it is a significant challenge for the stereo analysis approach to determine correspondence. To overcome the correspondence issue, active triangulation (also referred to as structured light) methods project known patterns of light onto an object to infer its shape. The geometry of the setup enables the calculation of the position of the surface on which the structured light falls by simple trigonometry.

Active triangulation methods may be broadly classified into three methods based upon the geometry of the structured light pattern projected on the surface of the object of interest.

Method 1—Point Projection:
Point projection based triangulation systems project a single point of light and must scan the point of light in two dimensions across the surface of the object of interest, typically using either mirrors or prisms, to obtain the surface range information. Since only one point is projected, there are less lateral resolution concerns with the imaging optics, since the center of the defocused spot can be estimated. For this case, lateral resolution is principally a function of the laser divergence. Point illumination based triangulation systems tend to be slower than other triangulation systems since the object is scanned a point at a time.

Method 2—Sheet of Light Projection:
Sheet of light based triangulation systems project a sheet of light across the surface of the object of interest causing the appearance of a line on the object's surface. Generally, the method requires a mechanism to scan the projected sheet of light across the scene in a manner such that the line sweeps across the surface of interest in the axis perpendicular to the sheet of light. The advantage of this type of triangulation system over point projection based triangulation systems is that it only requires a single axis scan since range data for the surface is being gathered along a line section of the surface, rather than just a point.

Method 3-2D Pattern Projection:
There is a broad range of two dimensional (2D) pattern projection based triangulation systems using two dimensional projections such as Moiré generated patterns or color- or shape-coded projected patterns, for example. The advantage of these types of systems is that they can generally be smaller and lower cost than point or sheet of light based systems since they project a 2D pattern over that surface of an object that is within the imaging camera's 2D field of view (full field) and hence can eliminate the need for mechanical translation of the projection pattern or imaging optics. The basic problem that 2D projection systems try to overcome is the identification of which imaged pattern element corresponds to which projected pattern element. In designing 2D projection systems, such as an intra oral optical impression system, the pattern spacing is limited by the expected surface variation. If the pattern is made too fine, surface variation of the object can create irresolvable ambiguity of pattern identification resulting in voids in the digital 3D model of the object's surface.

Of the three triangulation methods described above, the sheet of light projection method is unique in that it can be configured to circumvent the previously described trade-off between lateral resolution and depth of field. In order to achieve this independence of resolution and depth of field, the imaging system comprising the lens and image sensor must be physically oriented to one another so as to satisfy the Scheimpflug principle. The Scheimpflug principle is a geometric rule that describes the orientation of the plane of focus of an optical system (such as an image sensor or camera) wherein the lens plane is not parallel to the image plane. Normally, the lens and image (film or sensor) planes of an optical system (such as a camera) are parallel and the plane of focus is parallel to the lens and image planes. If a planar object being imaged (such as the side of a building) is also parallel to the image plane, it can coincide with the plane of focus, and the object's entire imaged surface can be rendered sharply. If on the other hand, the object's surface plane is not parallel to the image plane, the object's surface will be in focus only along a line where it intersects the plane of focus, a condition resulting in the classic lateral resolution versus depth of field trade-off.

Using the Scheimpflug principle, this trade-off can be avoided in a sheet of light projection triangulation system by orienting the image plane and lens plane such that when an oblique tangent is extended from the image plane, and another is extended from the lens plane, they will meet at a point through which the plane of focus also passes. If the sheet of light projection onto the object plane is made to coincide with this plane of focus, all points along the sheet of light line in the object plane will be in focus. This enables sheet of light based triangulation systems to maintain the high lateral resolution required for dental applications while providing a large depth of focus. For good fits of dental restorations, such as crowns and bridges, it is generally accepted that resolutions of 50 μm or less are needed for optical impression systems that capture the teeth of interest. For those optical dental impression systems that are not able to use the Scheimpflug principle, such as one using a 2D pattern projection, achieving the needed 50 μm resolution results in a depth of field of less than 4 mm. In contrast, sheet of light based intra oral scanners using the Scheimpflug principle can achieve 25 μm resolutions over a depth of field that exceeds 16 mm.

When a dentist prepares to take an intra oral optical impression, they generally require some form of feedback to allow them to know that they have properly positioned the intra oral probe. A 2D pattern projection based intra oral optical impression system can image its full field and much like an intra oral camera, can easily provide a live full field 2D video preview image that shows the dentist where the probe is located intra orally and how it is oriented with respect to a tooth for the optical impression. Similarly, intra oral optical impression systems based upon confocal macroscopy, like the Cadent iTero™, which projects a 2D pattern onto the surface but uses focus/defocus of the pattern image to determine range information instead of triangulation methods, can also make use of their full field imaging optics to provide a full field 2D video preview for the dentist. Typically, the lateral full field of view for a 2D pattern projection based intra oral optical impression system is in the range of 10 mm which results in the dentist seeing a two dimensional view that corresponds to a tooth to a tooth and a half of surface in the preview 2D image as they maneuver the probe intra orally. Then, once the dentists has finished positioning the probe intra orally, they take the 3D optical impression of the same tooth to tooth and a half surface being observed in the 2D preview image. In this regard, this is analogous to using the image finder in a camera to orient and frame the scene before you snap the actual picture.

In contrast, a sheet of light projection based intra oral optical impression system might move (also referred to as scan) the projected light and imaging optics across tens of millimeters of dentition surface (the scan path) along the axis perpendicular to the sheet of light, thus making the use of a full field 2D preview image impractical due to the constraints of the intra oral cavity on the allowed size of the intra oral probe and the necessary focusing optics needed to achieve such a wide-field 2D view. So, while a sheet of light projection based 3D optical impression system can have a larger depth of focus while maintaining good lateral resolution, the difficulty in using a sheet of light projection based intra oral optical impression system is that its probe must be properly oriented such that the probe is positioned to maintain a field of view of the dentition of interest along its entire scan path, a path that may be dozens of millimeters long and covering multiple teeth along the curved arch of the jaw.

One manner of dealing with this presently is for the dentist to intra orally position the probe as best they can, take an optical impression scan, look at the resulting display of the digital 3D model of the scanned dentition, adjust the position of the probe to correct for any misalignments observed in the 3D model, take a second optical impression scan, look at the new 3D model, adjust the probe position, etc. Using this trial and error approach, the dentist can iterate the probe position until either: 1) the probe is finally properly placed to capture the 3D optical impression of the group of teeth of interest to the dentist in one scan, in which case they can reject all of the previous scan and impression data; or 2) the dentist has iterated the probe position in enough ways across a group of optical impression scans such that the combined data from the ensemble of individual optical impression scans has captured the dentition of interest and the final digital 3D model representing the digital impression can be created. This trial and error approach is however inefficient and results in extra time on the part of the dentist (and patient) to get the digital impression for the dentition of interest. Further more, if the data from each of the full optical impression scans taken in this iterative process is kept and then processed as an ensemble of optical impression scans, it presents a significant challenge for the system to save all of the full optical impression scan data from each of the iterations and then attempt to merge all of the data into a digital 3D model that represents the composite of all of the optical impression scans. Currently then, there is no method that achieves both the required resolution across a depth of field that exceeds the dimensions of a tooth and a means to aid in quickly positioning the intra oral optical impression system's probe while minimizing the amount of optical impression scan data required to be captured, saved, and processed to generate the 3D model representing the digital impression. A 2D pattern based intra oral 3D optical impression system achieves a simple and intuitive means of providing a preview 2D image to the user to allow for proper probe positioning but at the expense of system resolution across the depth of field whereas the sheet of light projection based intra oral optical impression system provides the needed resolution across a large depth of field but can be inefficient for the dentist to optimally position intra orally.

### SUMMARY

In one aspect, a method to preview a three dimensional (3D) digital model includes placing a 3D scanner probe near an object to be scanned; scanning a portion of the object to generate a digital 3D model of the portion of the object; and displaying the digital 3D model of the portion as a live 3D preview of the digital 3D model, wherein the live 3D preview provides feedback on the probe's position and orientation relative to the object.

Implementations of the above aspect may include one or more of the following. The live 3D preview is displayed in near real-time. The live 3D preview is used to reposition the probe and aid in orienting the probe with respect to the surface of interest on an object being scanned. The live 3D preview model is at a reduced resolution. The system can capture a complete digital 3D model of the object's surface of interest after the live 3D preview. The 3D scanner probe sweeps structured light, such as a sheet of light, across one or more surfaces of the object. The object can be part of the masticatory system including one or more teeth. The 3D scanner probe can align with a dentition along a scan trajectory. The system can provide a 3D preview scan mode where the 3D scanner probe sweeps a sheet of light back and forth along all or part of a full scan path and the live 3D preview of the digital 3D model of the scanned surface is displayed. The probe can be adjusted until the dentition of interest is shown in the live 3D preview.

In another aspect, a method to preview a digital 3D model derived from a scan of one or more teeth includes placing a 3D scanner probe in a patient's mouth; scanning a dental structure to generate a digital three dimensional (3D) model of the scanned dental structure in the patient's mouth; and displaying a live 3D preview of the scanned dental structure.

Implementations of the above method may include one or more of the following. The 3D scanner probe sweeps a sheet of light across one or more surfaces of teeth. The 3D scanner probe can be positioned to align the probe with the patient's dentition along a scan trajectory. A preview scan mode for a dental professional can be provided where the sheet of light projector and imaging aperture within the scanner probe rapidly moves back and forth along all or part of the full scan path, and displaying a near real-time, live 3D preview of the digital 3D model of the scanned dentition. The live 3D preview display provides feedback on how the probe is positioned and oriented with respect to the patient's dentition. The live 3D preview can be used to adjust the scanner probe until a dentition of interest is shown in the live 3D preview display. The user can exit a preview scan mode and capture an optical impression of the dentition.

In another aspect, a method provides rapid and correct positioning of an intra oral optical impression scanner probe within the intra oral cavity by incorporating a preview scan mode by a) preparing the patient's dentition for an optical impression; b) utilizing a structured light scanner that moves the structured light projector and the associated imaging optics along a defined trajectory that can span one or more teeth in the jaw; and c) rapidly moving the structured light projector and the associated imaging optics back and forth along a defined trajectory while processing the scan data in near real-time and providing the user with a continuously updating display of the resultant digital 3D model of the scanned dentition.

Implementations of the above method may include the use by a dentist of a foot pedal to control: 1) the entry into the preview scan mode for finding the correct intra oral position and orientation of the scanner probe; and 2) the exit from the preview scan mode to capture a digital impression of the patient's dentition of interest.

### BRIEF DESCRIPTION OF THE DRAWINGS

FIG. 1A shows an exemplary process to preview a digital 3D model.

FIG. 1B shows an exemplary process to preview a digital 3D model for dental structures.

FIG. 2 is a block diagram illustrating an exemplary environment for viewing, altering, and archiving digital models of dental structures and for supporting computer integrated manufacturing of physical models of the dental structures using the digital model files.

FIG. 3 shows a system and method for previewing digital dental models and performing treatment planning.

### DESCRIPTION

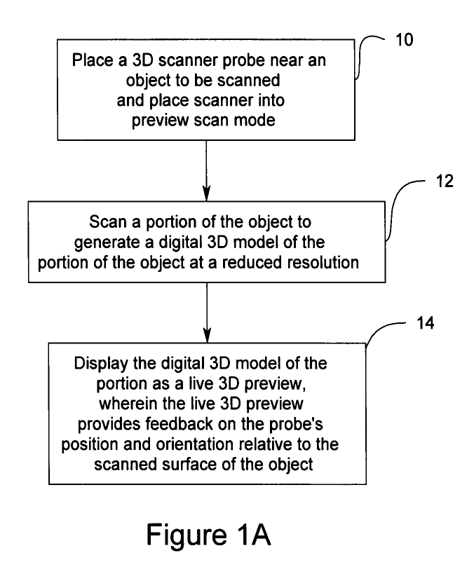

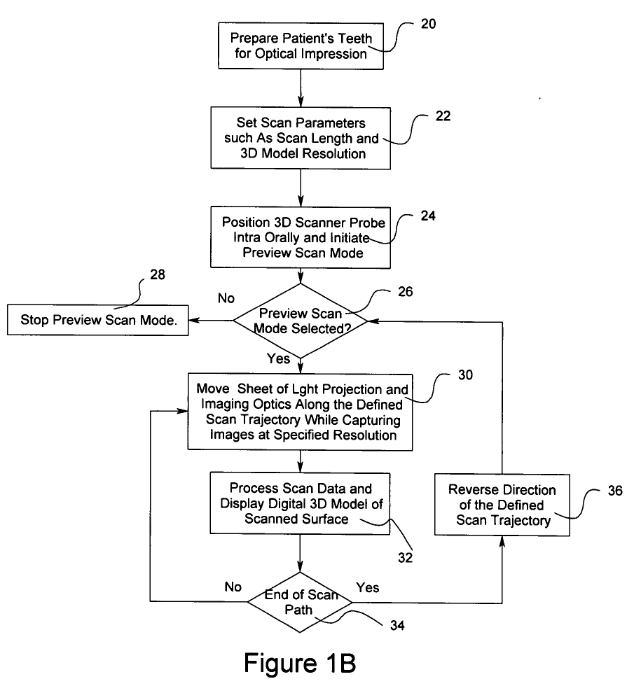

FIG. 1A shows a first exemplary process to preview a digital 3D model using a 3D scanner such as a sheet of light projection scanner. In this process, a 3D scanner probe is placed near an object to be scanned and the scanner system is put into a preview scan mode (10). While in preview scan mode, the system next scans a portion of the object to generate a digital three dimensional (3D) model of the portion of the object that was scanned by the system's projected light (12). In one embodiment, to speed up processing, the preview scan is done at a reduced resolution. A live 3D preview is accomplished by displaying the digital 3D model that reflects the most recently processed scan data (14). The process of scanning (12) and updating the display of the live 3D preview of the digital 3D model (14) repeats in a continuous fashion while in the preview scan mode. The live 3D preview provides feedback on the 3D scanner probe's position and orientation with respect to the scanned object's surface such that a change in the probe's position or orientation results in the update of the live 3D preview to display the digital 3D model representing the probe's current view of the object's surface along the preview scan trajectory. In one embodiment, while in preview scan mode, the scanner continuously sweeps the sheet of light back and forth along a scan trajectory that extends across more than 39 mm and displays a continuously updated live 3D preview of the digital 3D model of the surface being scanned. In one embodiment, the surface is continuously being scanned along a complete preview scan trajectory and the resultant live 3D preview of the digital 3D model is being updated and displayed at a rate of one or more times per second. The system enables a rapid scanning and digital 3D model rendering process to provide rapid alignment of one or more image apertures and the scan trajectory with the structure being scanned.

In one embodiment, a live 3D preview is shown to the user and provides a near real-time live showing of a digital 3D model of the scanned object to allow the operator or user to see ahead of time how the object will be scanned before the operator initiates the process to capture and save the data for a high quality digital 3D model of the scanned object. In another embodiment, the live 3D preview produces a 3D thumbnail model or a reduced resolution 3D model of a portion of the object so the operator can spot errors or inaccuracies in the 3D scanner probe placement prior to capturing and saving the data for a digital 3D model. In another embodiment, the scan data from the live 3D preview scan is used to generate a preview digital 3D model for display to the user and some or all of the preview scan data is saved and used to generate the final digital 3D model. In yet another embodiment, the scan data from the live 3D preview scan is used only to generate a preview digital 3D model for display to the user and the preview scan data is not saved or used to generate the final digital 3D model.

FIG. 1B shows a second exemplary process to preview a digital 3D model derived from a scan of dental structures such as teeth. In this process, the optical impression scanner system's intra oral probe (the 3D scanner probe) is positioned such that it is generally aligned with the patient's dentition along the scan trajectory. The system provides a preview scan mode for the dental professional or dentist where the 3D scanner probe's sheet of light projector and associated imaging optics are rapidly moved back and forth along all or part of the full scan path and a live 3D preview of the digital 3D model of the scanned surface is displayed back to the user in near real-time.

Turning now to FIG. 1B, the process starts by preparing the patient's teeth for an optical impression or scan (20). Next, an operator sets one more scan parameters such as scan length and 3D model resolution (22). The operator then positions the 3D scanner probe intra-orally in the patient and initiates the preview scan mode (24). The process checks to see if the preview scan mode is still selected (26) and if not, stops the preview scan mode (28). Alternatively, the process moves the scanner light projection and imaging optics along a predefined trajectory while capturing images at a specified resolution (30). The scan data is processed and the resulting digital 3D model of the scanned surface is displayed in real-time or near real-time (32). The process checks to see if the system has reached the end of the scan path (34). If not, the process loops back to step 30. Alternatively, if the end has been reached, the process reverses the direction of the predefined scan trajectory (36) and loops back to step 26.

The live 3D preview display will provide immediate feedback to the dentist on how the 3D scanner probe is positioned and oriented relative to the patient's dentition and allow them to quickly make adjustments of the probe until the digital 3D model of the dentition of interest to the dentist is being shown in the live 3D preview display. At this point the dentist would stop the preview scan mode and initiate the process to scan, capture, and save the actual high resolution digital 3D model of the dentition, i.e. capture the digital impression.

While in the preview scan mode, the sheet of light scanner is continuously moving the scanner's sheet of light projector and associated imaging optics back and forth along the defined scan trajectory. At the same time, data from each sweep of the scanner is processed in near real-time and the digital 3D model of the surface swept by the projected sheet of light is displayed to the user. In the preferred embodiment, near real-time means that the display latency between the time that the data is captured and it is displayed to the user as a live 3D preview of the digital 3D model is less than about 2 seconds and ideally less than about 0.5 second.

In one embodiment, the time to complete one complete sweep back and forth along the scan path is approximately one second which results in the display of the live 3D preview of a digital 3D model to the user being updated at a two frame per second rate. It has been found that such an update rate in conjunction with a display latency of less than 0.5 seconds provides good feedback to the dentist for positioning and orienting the probe in preparation for capturing and saving the actual optical impression of the dentition of interest. Faster or slower scan rates in combination with shorter or longer display latencies may also be utilized for the preview scan mode and are contemplated by the inventors.

In a preferred embodiment, a structured light scanner such as a sheet of light projection scanner is used as a 3D scanner. The structured light scanner may be broadly classified by the number of dimensions that are mechanically scanned. Sheet of light projection scanners project a sheet of light across the scene causing the appearance of a line on the object. The advantage of these types of scanners over point scanners is that the range data for a scene is being gathered along a line section of the surface being scanned, rather than just a point. Similar to a point scanner, this method requires a mechanism to scan the projected laser line across the scene in a manner such that the line sweeps across the surface of interest in the axis perpendicular to the sheet of light.

Other 3D scanners such as point scanners or 2D projection scanners can be used as well. Point scanners project a single point and scan it across the scene, typically using mirrors or prisms. Since only one point is projected, there are less lateral resolution concerns with the imaging optics, since the center of the defocused spot can be computed. 2D projection systems can use two dimensional projections such as Moiré generated patterns or color- or shape-coded projected patterns, among others. The 2D projection systems are generally smaller and lower cost than point or sheet of light projection scanners. These systems typically project a 2D pattern over two dimensions of the object (full field) and hence can eliminate the need for mechanical translation of the pattern projector or imaging optics. However, in cases where the size of the object of interest exceeds the full field view of the 2D pattern projection it may be advantageous to mechanically translate (scan) the pattern projector and imaging optics in a manner such that a series of images of the projected 2D pattern on the object are captured along a scan trajectory. In this case, the live 3D preview process described herein would be applicable for getting the scan trajectory aligned with the object of interest, for example a specific set of dentition along a jaw line.

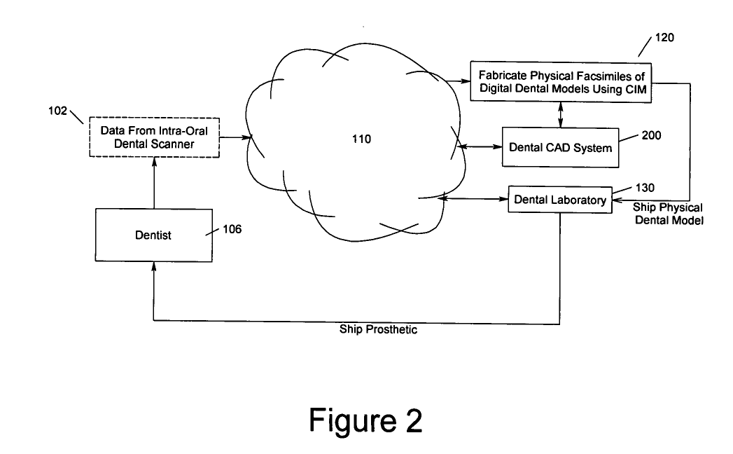

FIG. 2 is a block diagram that illustrates an exemplary environment for viewing, altering, and archiving digital models of dental structures and for supporting computer integrated manufacturing of physical models of the dental structures using the digital model files. In the environment of FIG. 2, data obtained by an intra-oral dental scanner 102 of the dental structures is used to create a 3D digital dental model that is representative of the surface contour of the scanned dental structures. Descriptions of the method and apparatus to obtain this digital dental model are described in U.S. Pat. No. 6,364,660, the contents of which are incorporated by reference herein.

The data representing the digital dental model from the scanner 102 is transferred over a wide area network 110 such as the Internet to a dental laboratory facility 130 with computer aided manufacturing capabilities. Using the Dental CAD System 200 a dental laboratory technician may view the digital dental model and select those teeth for which a tooth die model is desired. The Dental CAD System 200 would then create 3D digital isolated tooth die models of the selected teeth. The technician could then select which of the digital models should be fabricated into a physical model utilizing Computer Integrated Manufacture (CIM) methods and technologies such as Stereo Lithography Apparatus (SLA). Typically, a CIM fabricated isolated tooth die model would be used as a pattern to fabricate a prosthetic such as a crown that would then be shipped directly back to the dentist 106.

In some cases, the dentist 106 may transfer the digital dental model file to a CIM facility 120. The CIM facility 120 may choose to make dentist-sanctioned modifications to the digital dental model and then fabricate the physical replicates of the digital dental model and the digital isolated tooth die model following the processes described previously for the dental laboratory 130. Once the physical models of the digital dental model and the digital isolated tooth die model are made, the physical models would be shipped to a designated dental laboratory 130 for prosthetic fabrication.

The system of FIG. 2 integrates the creation of digital dental models with CIM to fabricate accurate physical model representations of the digital models. The CIM technologies that are suitable for fabrication of physical models of the digital models includes, but is not limited to stereo lithography apparatus (SLA), computer numeric controlled (CNC) machining, electro-discharge machining (EDM), and Swiss Automatics machining. For example, SLA equipment and 3D printers such as the ThermoJet printer are available from 3D Systems, Inc. of Valencia, Calif. that allows CAD users the freedom to quickly “print” and hold a three dimensional model in their hands.

In stereolithography, three dimensional shape model data is converted into contour line data and sectional shapes at respective contour lines are sequentially laminated to prepare a cubic model. Each cubic ultraviolet-ray curable resin layer of the model is cured under irradiation of a laser beam before the next layer is deposited and cured. Each layer is in essence a thin cross-section of the desired three-dimensional object. Typically, a thin layer of viscous curable plastic liquid is applied to a surface which may be a previously cured layer and, after sufficient time has elapsed for the thin layer of polymerizable liquid to smooth out by gravity, a computer controlled beam of radiation is moved across the thin liquid layer to sufficiently cure the plastic liquid so that subsequent layers can be applied thereto.

The waiting period for the thin layer to level varies depending on several factors such as the viscosity of the polymerizable liquid, the layer thickness, part geometry, and cross-section, and the like. Typically, the cured layer, which is supported on a vertically movable object support platform, is dipped below the surface of a bath of the viscous polymerizable liquid a distance greater than the desired layer thickness so that liquid flows over the previous cross-section rapidly. Then, the part is raised to a position below the surface of the liquid equal to the desired layer thickness, which forms a bulge of excess material over at least a substantial portion of the previous cross-section. When the surface levels (smooth out), the layer is ready for curing by radiation. An ultraviolet laser generates a small intense spot of UV which is moved across the liquid surface with a galvanometer mirror X-Y scanner in a predetermined pattern. In the above manner, stereolithography equipment automatically builds complex three-dimensional parts by successively curing a plurality of thin layers of a curable medium on top of each other until all of the thin layers are joined together to form a whole part such as a dental model.

As can be appreciated, each patient's dental model is unique and a patient's dental models are typically manufactured one at a time by a skilled dental technician. In contrast to this “one-at-a-time” manual fabrication of models, the use of SLA allows for the mass manufacturing of patient dental models since the platform can be sectioned into grids where each grid can support a unique set of dental model parts. In addition, these unique grid model parts can be serialized during manufacturing to allow tracking of individual parts throughout the dental laboratory process.

For a typical single tooth crown patient, three unique physical models would be made: 1) A physical model of all or part of the teeth and adjacent gingiva in the digital dental model derived from scanning the dental structures in the upper jaw; 2) A physical model of all or part of the teeth and adjacent gingiva in the digital dental model derived from scanning the dental structures in the lower jaw; and 3) A physical model of the digital isolated tooth die model for the tooth being crowned. The upper and lower jaw physical models would be fabricated with index marks allowing the lab technician or dentist to align the physical models in the proper occlusal relationship. Once the dental technician has fabricated the crown using the physical model of the digital isolated tooth die model as a pattern, the crown can be checked for fit by seating it on the corresponding tooth location of the physical model created from the digital dental model for the upper or lower jaw. This allows for an accurate check of both adjacent tooth interference and occlusal fit of the fabricated crown prosthetic prior to shipping the crown prosthetic to the dentist.

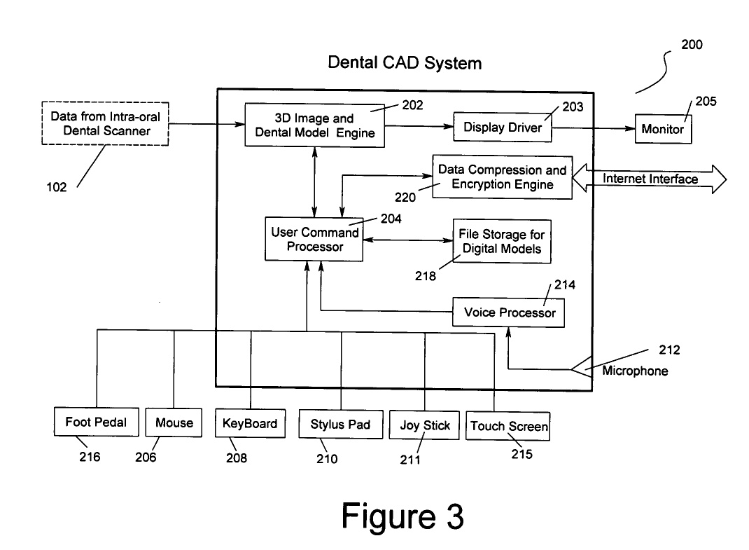

Referring now to FIG. 3, a dental CAD system 200 for viewing digital dental models and performing treatment planning is presented. Data from an intra-oral dental scanner 102 is processed by a 3D image and dental model engine 202 and displayed as a scaled 3D view of the dental structures.

The 3D image and dental model engine 202 also assesses the quality of the acquired digital dental model and can display to the user highlighted regions where the digital dental model reflects an anomalous surface contour, or where uncertainties in the calculated estimate of the surface contour exceeds a user specified limit. The output of the 3D image and dental model engine 202 is provided to a display driver 203 for driving a display or monitor 205.

The 3D image and dental model engine 202 communicates with a user command processor 204, which accepts user commands generated locally or over the Internet. The user command processor 204 receives commands from a local user through a foot pedal 216, mouse 206, a keyboard 208, a stylus pad 210, a joystick 211, or touch screen 215. Additionally, a microphone 212 is provided to capture user voice commands or voice annotations. Sound captured by the microphone 212 is provided to a voice processor 214 for converting voice to text. The output of the voice processor 214 is provided to the user command processor 204. The user command processor 204 is connected to a data storage unit 218 for storing files associated with the digital dental models. In one embodiment, the foot pedal 216 is used to control entry into a preview scan mode of the system, and is also used to control the exit from the preview scan mode and initiate the capture of the optical impression data used to create a digital dental model.

While viewing the 3D representation of the digital dental model, the user may use foot pedal 216, mouse 206, keyboard 208, stylus pad 210, joy stick 211, touch screen 215 or voice inputs to control the image display parameters on the monitor 205, including, but not limited to, perspective, zoom, feature resolution, brightness and contrast. Regions of the 3D representation of the digital dental model that are highlighted by the dental CAD system as anomalous are assessed by the user and resolved as appropriate. Following the user assessment of the displayed 3D digital dental model, the dental CAD system provides the user with a data compression and encryption engine 220 to process files for secure transmission over the internet.

The dental CAD system 200 also provides the user with tools to perform a variety of treatment planning processes using the digital dental models. Such planning processes include measurement of arch length, measurement of arch width and measurement of individual tooth dimensions.

Advantages of the certain embodiments of the above systems and methods may include one or more of the following. The system enables a rapid scanning and digital 3D model rendering process to provide rapid alignment of one or more image apertures and the scan trajectory with the structure being scanned. The live 3D preview of a digital 3D model displayed by the system enables rapid orientation of the intra oral probe independent of the scan path length without compromising the final digital 3D model accuracy or resolution of the scanner system. The system minimizes the trial and error process currently required for the dentist to find the right intra oral position and orientation of the 3D scanner probe and reduces the amount of data required to be processed to generate a final high resolution digital 3D model of the dentition. The near real-time display of the live 3D preview of a digital 3D model allows the dentist to quickly position a 3D scanner probe in a direct and intuitive manner. The system greatly speeds up the optical impression capturing process. With the trial and error process it typically takes as long as 20 seconds for the data from a single scan of an optical impression scanner to be captured, saved, processed, and displayed to the user as a digital 3D model of the optical impression. This is a considerable time for both the dentist and the patient, given that it may take two or three iterations to reach the probe position and orientation that's aligned with the dentition of interest for the final optical impression. The system eliminates the need to place optics for a full field 2D imager in the probe tip as required to provide an intra oral camera like two dimensional preview image for positioning the probe. The elimination of the 2D full field optics for a preview image allows the size of the 3D scanner probe tip to be minimized which gives the dentist more maneuverability of the probe within the intra oral cavity and increased visual access to the dentition. The above benefits are provided while being more comfortable for the patient during the 3D scanning and optical impression process.

While the present invention has been described in connection with certain preferred embodiments, it will be understood that it is not limited to those embodiments. On the contrary, it is intended to cover all alternatives, modifications and equivalents as may be included within the spirit and scope of the invention as defined in the appended claims.

What is claimed is:

1. A method to preview a three dimensional (3D) digital model of an object, comprising:
placing a 3D scanner probe near the object to be digitally modeled;
scanning a portion of the object to generate a digital 3D model of the portion of the object; and
displaying a live 3D preview of the digital 3D model, wherein the live 3D preview provides feedback on the probe's position and orientation relative to the object.

2. The method of claim 1, wherein the live 3D preview is displayed in near real-time.

3. The method of claim 1, wherein the live 3D preview is used to reposition the 3D scanner probe to determine a position that provides a digital 3D model of a desired portion of the object.

4. The method of claim 1, comprising capturing a high quality digital 3D model of a desired portion of the object after displaying the live 3D preview.

5. The method of claim 1, wherein the object is scanned at a reduced resolution.

6. The method of claim 1, wherein the 3D scanner probe sweeps a sheet of light across one or more surfaces of the object.

7. The method of claim 1, wherein the object comprises one or more teeth.

8. The method of claim 7, comprising positioning of the 3D scanner probe to align with a dentition along a scan trajectory.

9. The method of claim 7, comprising providing a preview scan mode where the 3D scanner probe sweeps a sheet of light back and forth along one or more portions of a full scan path and displaying the live 3D preview of the scanned surface.

10. The method of claim 7, comprising adjusting the probe position and orientation until a dentition of interest is displayed in the live 3D preview.

11. A method to preview a digital three dimensional (3D) model of one or more teeth, comprising:
placing a 3D scanner probe in a patient's mouth;
scanning a dental structure to generate a digital 3D model of the scanned dental structure in the patient's mouth; and
displaying a live 3D preview of the digital 3D model of the scanned dental structure.

12. The method of claim 11, wherein the 3D scanner probe sweeps a sheet of light across one or more surfaces of teeth.

13. The method of claim 11, comprising positioning the 3D scanner probe to align the probe with the patient's dentition along a scan trajectory.

14. The method of claim 11, comprising providing a preview scan mode for a dental professional where the scanner probe rapidly scans back and forth along one or more portions of a full scan path and displaying the live 3D preview of the digital 3D model near real-time.

15. The method of claim 11, wherein the live 3D preview display of the digital 3D model provides feedback on a position and orientation of the 3D scanner probe.

16. The method of claim 11, wherein the live 3D preview of the digital 3D model is used to adjust the 3D scanner probe until a dentition of interest is shown in the live 3D preview display.

17. The method of claim 11, comprising exiting a preview scan mode and taking a digital impression of the teeth.

18. A method for positioning an intra oral 3D scanner within the intra oral cavity of a patient, said method comprising:
a) preparing the patient's dentition for an optical scan;
b) utilizing a structured light scanner that moves a structured light projector and imaging optics along a defined trajectory spanning one or more teeth in the patient's jaw; and
c) moving the structured light projector and the imaging optics back and forth along the defined trajectory providing a continuously updated live 3D preview of a digital 3D model of the scanned dentition.

19. The method of claim 18, comprising using a foot pedal to control the intra oral 3D scanner.

20. The method of claim 19, wherein the foot pedal is used to control the display of the live 3D preview.
